(19) United States
(12) Patent Application Publication
(10) Pub. No.: US 2003/0198528 A1
(43) Pub. Date: Oct. 23, 2003

(54) Torque specifying nut

(76) Inventors: Masakatsu Onishi, Osaka (JP); Kazuhisa Kawahara, Osaka (JP)

Correspondence Address: Striker, Striker & Stenby, 103 East Neck Road, Huntington, NY, 11743, US

(21) Appl. No.: 10/408,725

(22) Filed: Apr. 7, 2003

(30) Foreign Application Priority Data
Apr. 12, 2002 (JP) 2002-111184

(51) Int. Cl. F16B 31/00; F16B 33/04

(52) U.S. Cl. 411/2

(57) ABSTRACT

There is provided a torque specifying nut which is suitable for being applied to a wind-fastening strap metal piece, capable of clamping only up to a specified clamping torque and capable of confirming whether clamping has been finished or not at a glance.

The torque specifying nut is integrally formed with a nut main body having a female screw hole and a torque operating portion having a tool applying face at an outer side thereof, in which the torque operating portion is formed with a noncircular hole concentric with the female screw hole and having a diameter larger than a diameter of the female screw hole from an end face thereof over to the nut main body and at a boundary portion of the nut main body and torque operating portion, at least two of fragile portions are provided to surround the noncircular hole.

### FIELD OF THE INVENTION

The present invention relates to a nut, particularly to a nut capable of specifying clamping torque.

### DESCRIPTION OF THE RELATED ART

There is frequently a case in which fastening or clamping by a nut is carried out in a state in which a bolt or a screw shaft is not rotated.

As an example thereof, there is a wind-fastening strap metal piece. The metal piece is used for fixing a coupling metal piece in the form of a collar or a flange to an end portion of a hose in order to connect the hose to other hose or apparatus.

As can be understood in reference to a related art (FIGS. 28A, 28B), such an wind-fastening strap metal piece is constituted by a set of a compressible ring wound with a wire rod formed with male screws in required ranges of two free end portions thereof by about 1.5 turns such that two ends thereof are extended in the same direction, a holder plate having a curved face in correspondence with a radius of curvature of the wire rod and formed with guide cylinders for loosely inserting the respective male screws at two end portions thereof and nuts.

When the metal piece is used, a boss portion of a coupling metal piece is previously inserted into a hose from an opening of an end portion of the hose, the wind-fastening strap metal piece is fitted to an outer periphery of the hose, the nuts are screwed to the male screws projected from the semicylindrical guides to thereby clamp the compressible ring by contracting a diameter thereof.

As the nut, in the related art, an ordinary nut constituting an outer periphery thereof by a polygonal shape and formed with a female screw at an inner diameter thereof has been used. However, according to the nut, adjustment of clamping torque mainly depends on experience or hunch of an operator and therefore, a deficiency in fixing the wind-fastening strap metal piece to the coupling metal piece is brought about by a deficiency in the clamping torque, the coupling metal piece is liable to detach or high pressure fluid is liable to leak. Or, conversely, the clamping torque becomes excessively large, the hose is cracked, cut or destructed and there is a concern of amounting to a serious accident by jetting out high pressure fluid thereby. Further, by applying torque excessively, there is a concern of destructing the female screw or the male screw.

### SUMMARY OF THE INVENTION

The invention has been carried out in order to resolve the above-described problem and it is an object thereof to provide a torque specifying nut capable of clamping by a specified clamping torque accurately and firmly and capable of determining whether clamping has been finished or not at a glance.

In order to achieve the above-described object, according to an aspect of the invention, there is provided a torque specifying nut integrally formed with a nut main body having a female screw hole and a torque operating portion having a tool applying face at an outer side thereof, wherein the torque operating portion is formed with a noncircular hole concentric with the female screw hole and having a diameter larger than a diameter of the female screw hole from an upper end face thereof by a depth reaching the nut main body and at a boundary portion of the nut main body and the torque operating portion, as a torque restraining portion, a plurality of fragile portions are arranged around the noncircular hole at intervals in a peripheral direction.

Preferably, the fragile portion is constituted by forming a necked portion at the boundary portion of the nut main body and torque operating portion and changing a thickness of a wall thereof surrounding the noncircular hole in the peripheral direction by a relationship between the necked portion and the noncircular hole.

The fragile portions are provided at at least two locations at equal intervals on a circumference and the fragile portion includes a case in which the fragile portion constitutes a window hole communicating the noncircular hole and outside thereof.

According to the above-described constitution, the fragile portions having weak strength are present at least at two location on the circumference and therefore, when clamping torque is applied via the torque operating portion and the clamping torque reaches a constant limit, the boundary portion of the nut main body and torque operating portion is twisted to cut and the torque operating portion is broken to separate from the nut main body and thereafter, the torque cannot be applied further and therefore, the clamping can be carried out accurately and firmly by the specified clamping torque. Further, the shape is changed by breaking to separate the torque operating portion from the nut main body and therefore, whether clamping operation has been finished or not can be determined at a glance. Further, the structure is simple and can be fabricated inexpensively.

The noncircular hole may be constituted by a planar polygonal shape or a shape similar thereto and may be a deformed shape having a large diameter hole and a vertical position projected to an inner diameter side thereof.

The nut main body may be provided with a tool applying face at a portion thereof. When the tool applying face is provided in this way, the nut can be loosened to remove later and can be reused as an ordinary nut.

The nut of the invention can be used not only for a wind-fastening strap metal piece but in various uses and fields requiring clamping by constant torque under a condition in which a bolt or a screw shaft is prevented from being rotated.

Although other characteristic or advantage of the invention will become apparent by the detailed description as follows, so far as the basic characteristic of the invention is provided, the invention is not limited to constitutions shown in embodiments but it is apparent that a person skilled in the art can change or modify the invention variously without deviating from the range of the invention.

### BRIEF DESCRIPTION OF THE DRAWINGS

FIG. 1 is a plane view showing a first mode of a torque specifying nut according to the invention;

FIG. 2 is a bottom view of the nut of the first mode;

FIG. 3 is a sectional view taken along a line III-III of FIG. 1;

FIG. 4 is a sectional view taken along a line IV-IV of FIG. 1;

FIG. 5 is a sectional view taken along a line V-V of FIG. 4;

FIG. 6A is a sectional view showing a state in the midst of applying torque;

FIG. 6B is a sectional view showing a state after reaching a specified torque;

FIG. 7 is a partially cut front view showing a second mode of a nut according to the invention;

FIG. 8 is the side view of the nut of the second mode;

FIG. 9 is a plane view of the nut of the second mode;

FIG. 10 is a sectional view taken along a line X-X of FIG. 7;

FIG. 11A is a vertical sectional view showing a state in use;

FIG. 11B is a vertical sectional view showing a state when a specified torque is reached;

FIG. 12A through FIG. 12D are cross-sectional views respectively showing other modes of a torque specifying portion in a nut of the invention;

FIG. 13A through FIG. 13C are cross-sectional views exemplifying other modes of a shape of a noncircular hole and a torque specifying portion in a nut of the invention;

FIG. 14 is a plane view of a third mode of a nut of the invention;

FIG. 15 is a partially cut front view taken along a line XV-XV of FIG. 14;

FIG. 16 is a plane view of a fourth mode of a nut of the invention;

FIG. 17 is a partially cut front view taken along a line XVII-XVII of FIG. 16;

FIG. 18 is a plane view of a fifth mode of a nut of the invention;

FIG. 19 is a partially cut front view of the fifth mode;

FIG. 20 is a partially cut front view taken along a line IIX-IIX of FIG. 18;

FIG. 21 is a cross-sectional view showing a state of the fifth embodiment when a specified torque is reached;

FIG. 22 is a partially cut side view showing an example of using a nut of the invention in a wind-fastening strap metal piece;

FIG. 23A is a sectional view taken along a line IIXIII-IIXIII of FIG. 22;

FIG. 23B is a sectional view of a state of finishing fastening;

FIG. 24 is a sectional view showing other example of using a nut of the invention in a state before clamping and a state when a specified torque is reached;

FIG. 25 is a perspective view showing other example of using a nut of the invention;

FIG. 26 is a partial sectional view of FIG. 25;

FIG. 27 is a partially cut front view showing other example of using a nut of the invention; and

FIG. 28A is a perspective view of a wind-fastening strap metal piece assembly of a related art and FIG. 28B is a partially cut side view thereof.

### DETAILED DESCRIPTION OF PREFERRED EMBODIMENTS

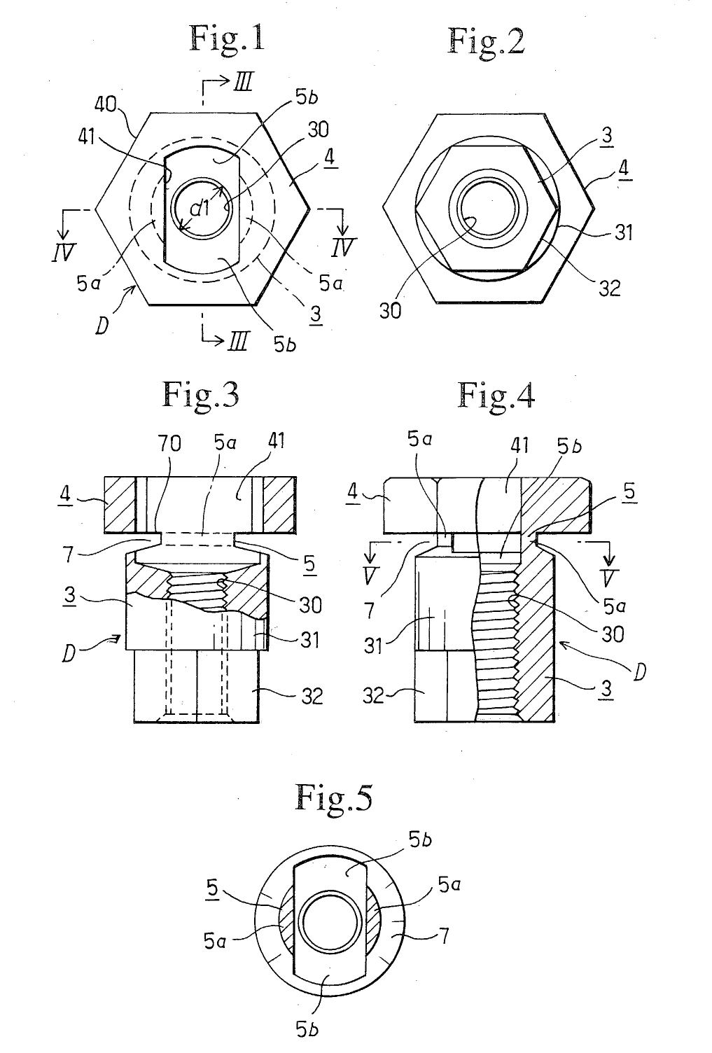

When the embodiments of the invention is explained in reference to the attached drawings, FIG. 1 through FIG. 6B show a first mode and a total of a torque specifying nut of the invention is designated by notation D. According to the torque specifying nut D, a nut main body 3 and a torque operating portion 4 are integrally connected via a torque restraining portion (breaking portion) 5.

The nut main body 3 includes a female screw hole 30 at a region from a lower end thereof over a required length and is provided with a cylindrical portion 31 and a tool applying portion 32 in a polygonal shape at an outer face thereof. The tool applying portion 32 is provided when the nut needs to be removed later or is reused as an ordinary nut and therefore, the tool applying portion 32 may not be provided depending on cases.

The torque operating portion 4 is constituted such that an outer diameter thereof is larger than that of the nut main body 3 in this example and includes a tool applying portion 40 in a polygonal shape for applying torque at an outer periphery thereof.

The torque operating portion 4 includes a noncircular hole 41 having a depth reaching a region of the nut main body 3 from a top face thereof. The noncircular hole 41 communicates with the female screw hole 30 and a center thereof coincides with a center of the female screw hole 30.

As shown by FIG. 1, the noncircular hole 41 is constituted to be larger than a diameter d1 of the female screw hole 30. This is indispensable for permitting projection of a screw shaft. According to the embodiment, the noncircular hole 41 constitutes substantially a rectangular shape or a shape similarly thereto in view from a plane.

The torque restraining portion 5 is a wall surrounding the noncircular hole 41 and includes two pieces or more of fragile portions 5b at intervals in a peripheral direction thereof. The torque restraining portion 5 is fabricated by forming a necked portion 7 at a boundary portion of the torque operating portion 4 and the nut main body 3. The necked portion 7 is provided by machining by a cutting tool of a bit or the like or slenderizing by drawing such that a front end 70 thereof reaches or becomes proximate to the noncircular hole 41.

Although the depth of the necked portion 7 is uniform over a total periphery thereof, since the noncircular hole 41 is present on an inner side thereof, by a relationship therewith, a wall thickness of the wall of the torque restraining portion 5 is not uniform over the total periphery but is changed and as shown by FIG. 5, and strength portions 5a each having a predetermined wall thickness and the fragile portions 5b are alternately formed.

According to the example, the wall thickness of the fragile portion 5b is provided with null wall thickness, that is, constituted as window holes at two locations at intervals of 180 degrees and therefore, only the strength portions 5a at two locations constituting a shape of a split circle constitute a torque transmitting portion connecting the torque operating portion 4 and the nut main body 3.

The strength portion 5a and the fragile portion 5b are arbitrarily be set by adjusting either or both of a size of the noncircular hole 41 and a diameter of the necked portion 7.

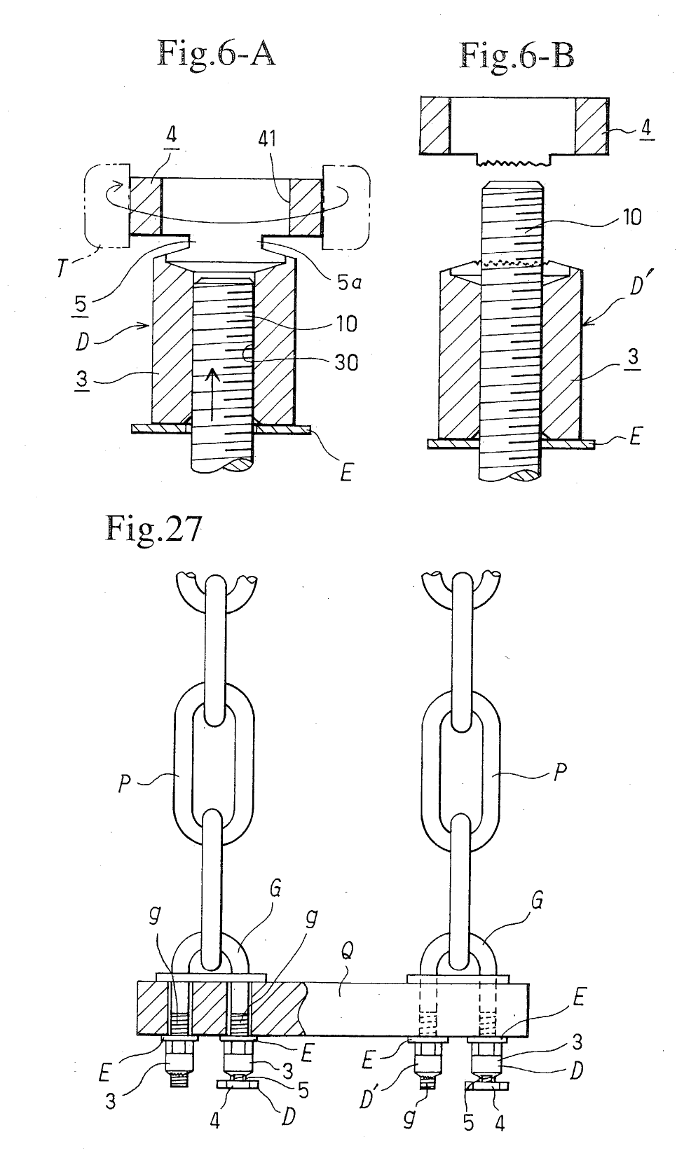

FIGS. 6A and 6B show states of using the first mode, FIG. 6A shows a state before reaching a specified torque and FIG. 6B shows a state after reaching the specified torque, respectively, and an explanation thereof will be given later.

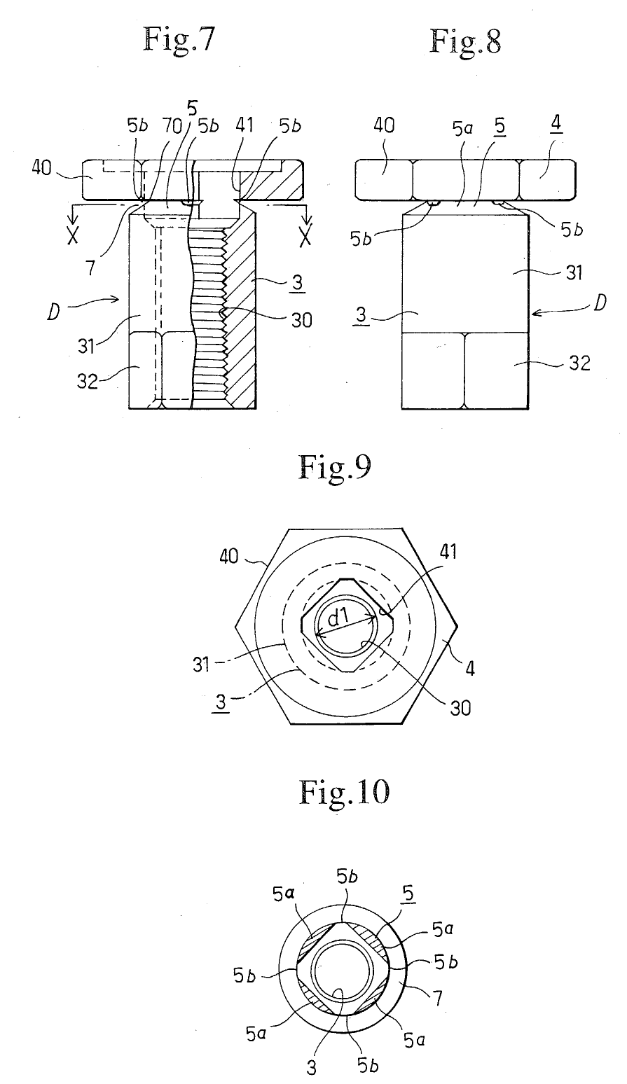

FIG. 7 through FIG. 11B show the second mode of a torque specifying nut of the invention.

According to the mode, a noncircular hole 41 constitute a planar regular quadrangular shape or a shape similar thereto and from such a relationship, the strength portions 5a and the fragile portion 5b of the torque restraining portion 5 are alternately arranged at four locations on a circumference. Other constitution is similar to that of the first mode and therefore, the same portions are attached with the same notations and an explanation thereof has been given by the above-described explanation.

The above-described is several examples of the invention and the invention is not limited thereto.

1) Various modes can be adopted for the strength portion 5a and fragile portion 5b of the torque restraining portion 5 in accordance with a magnitude of torque intended to be specified. For example, when the noncircular hole 41 is constituted by a constant size, the specified torque is adjusted by a depth of machining the necked portion 7.

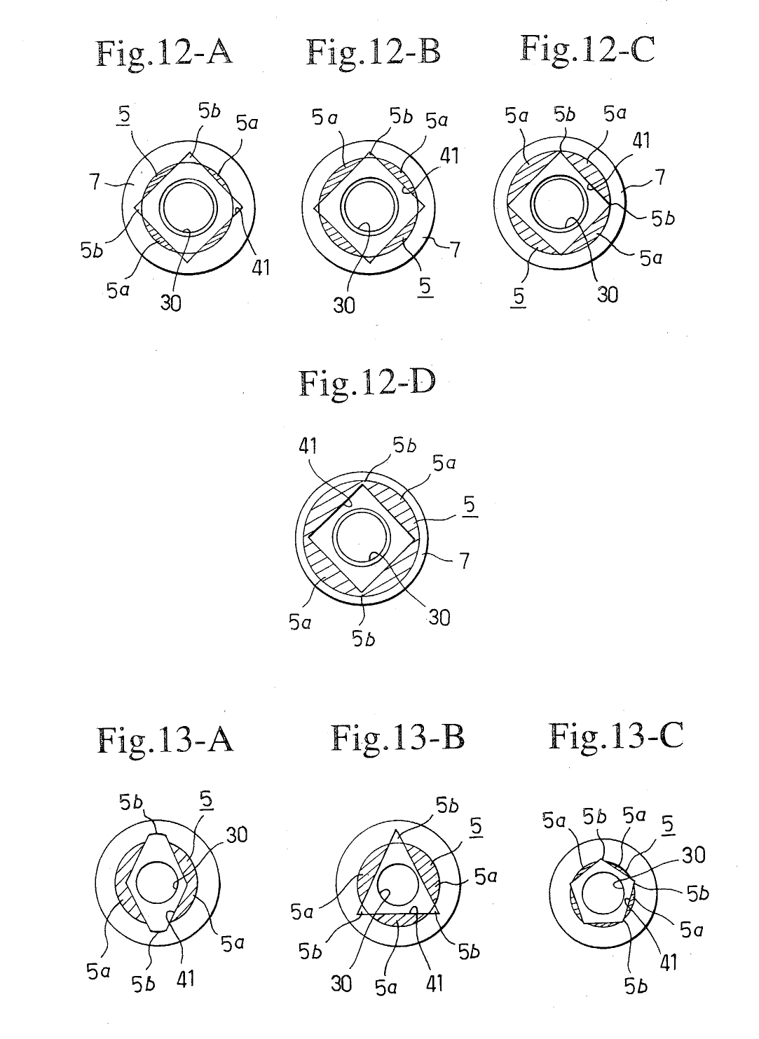

FIGS. 12A through 12D show the modes, and by deepening the necked portion 7, the size of the fragile portion 5b is increased as shown by FIG. 12A and therefore, a comparatively small specified torque can be constituted. Conversely, by shallowing the necked portion 7, the size of the fragile portion 5b is relatively reduced as shown by FIG. 12B, the specified torque can relatively be increased. Further, when the necked portion 7 is shallowed further, a rate of occupying the strength portion 5a in the section is increased as shown by FIG. 12C and therefore, the specified torque can be set to increase further. In FIG. 12C, the window hole as the fragile portion 5b is reduced to be proximate to a point and in FIG. 12D, the fragile portion 5b remains as a wall having a thin wall thickness.

2) The number of the strength portion 5a and the fragile portion 5b of the torque restraining portion 5 is not limited to two or four. Further, also the shape of the noncircular hole 41 is not limited.

FIGS. 13A through 13C show the examples and in FIG. 13A, the noncircular hole 41 is constituted by a shape similar to a rhombic shape or an oval shape and the fragile portions 5b are formed at two positions symmetric with each other by 180 degrees. In FIG. 13B, the noncircular hole 41 is constituted by a triangular shape and three of the fragile portions 5b are formed at intervals of 120 degrees. In FIG. 13C, the noncircular hole 41 is constituted by a regular pentagonal shape and five of the fragile portion 5b are formed.

3) The size of the torque operating portion 4 is not necessarily limited to a case of being larger than that of the nut main body 3.

FIG. 14 and FIG. 15 show the example (third mode) and the torque operating portion 4 is constituted with an outer diameter substantially the same as that of the nut main body 3. Other constitution is similar to that of the first mode and therefore, an explanation thereof will be omitted.

FIG. 16 and FIG. 17 show another example (fourth mode).

According to the embodiment, the torque operating portion 4 is constituted with an outer diameter substantially the same as that of the nut main body 3 and the tool applying portion 32 of the nut main body 3 is provided not at a lower half portion thereof but an upper half portion thereof continuous to the necked portion 7. Other constitution is similar to that of the first mode and therefore, an explanation thereof will be omitted.

4) The shape of the noncircular hole 41 may not be a polygonal shape.

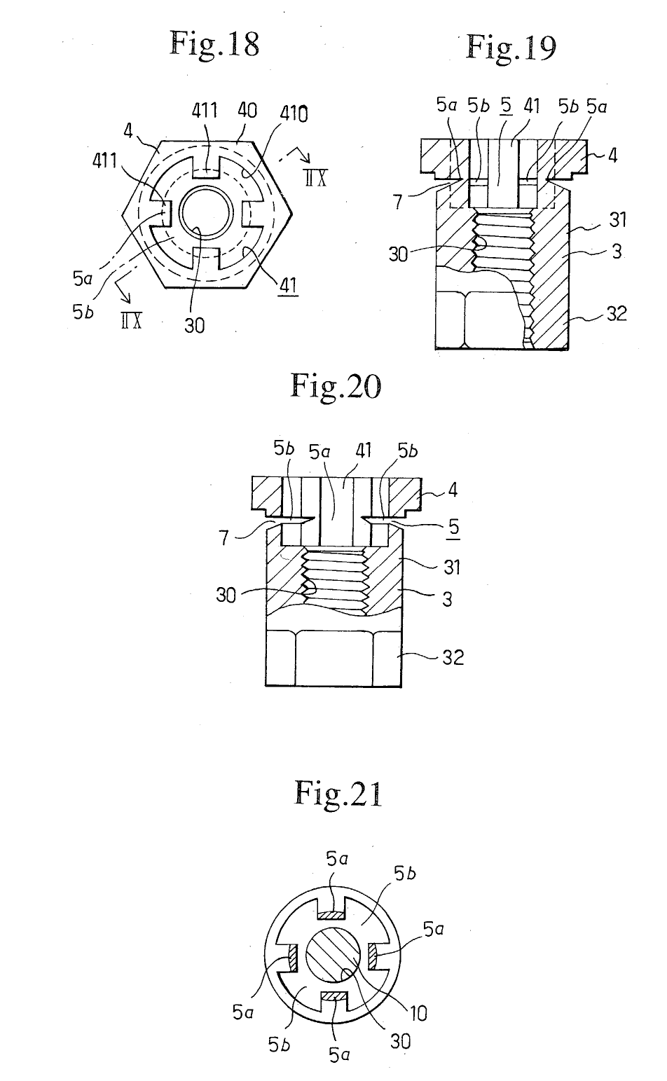

FIG. 18 through FIG. 21 show the example (fifth mode) and the noncircular hole 41 reaching the nut main body 3 from the torque operation portion 4 is constituted by a large diameter hole 410 in a shape of a true circle concentric with the female screw hole 30 and larger than the female screw hole 30 and a plurality (four in this example) of vertical projection 411 projected to an inner diameter side of the large diameter hole 410. A diameter connecting front ends of the vertical projections 411 in view from a plane is larger than that of the female screw hole 30.

The front end of the necked portion 7 rides over the large diameter hole 410 and reaches pertinently in front of projected ends of the vertical projections 411, thereby, the fragile portions 5b of the torque restraining portion 5 are formed in the form of window holes among the respective vertical projections 411.

Further, although in this example, the torque operating portion 4 is larger than the nut main body 3, the torque operating portion 4 may be constituted with a size the same as that of the nut main body 3 as in the second and the third embodiments.

### EXAMPLE OF USE

Next, an explanation will be given of examples of using the torque specifying nut D according to the invention.

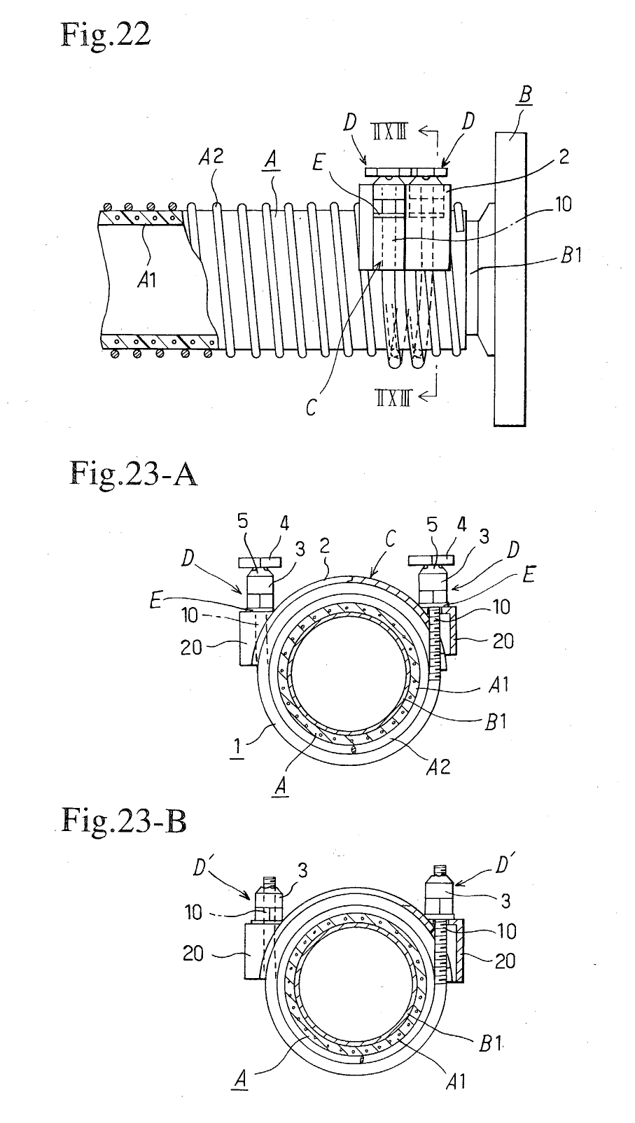

FIG. 22 and FIGS. 23A and 23B show an example of applying the torque specifying nut D in clamping a wind-fastening strap metal piece.

Notation A designates a pressure resistant hose which is constituted by winding and bonding a wire rod A2 made of synthetic resin spirally around an outer periphery of a hose main body A1 incorporated with reinforcing fiber. Notation B designates a coupling metal piece in which a boss portion B1 is inserted from an opening of an end portion of the pressure resistant hose A to an inner portion thereof. Notation C designates a wind-fastening strap metal piece which is fitted to the outer periphery of the pressure resistant hose A inserted in the boss portion B1 and used to clamp it. Notation E designates a washer.

The wind-fastening strap metal piece C is provided with a compressible ring 1 wound with the wire rod formed with male screws 10 at required ranges of two end portions thereof by about 1.5 turns such that both end portions thereof are projected in the same direction and a holder plate 2 having a curved face in correspondence with a radius of curvature of the wire rod and formed with cylindrical guides 20 for loosely inserting the male screws 10 into two end portions thereof. According to the example, the torque specifying nut D of the invention is used as means for clamping the pressure resistant hose A to the boss portion B1 by contracting a diameter of the compressible ring 1. That is, as shown by FIG. 23A, the torque specifying nut D is screwed to the male screw 10 of the compressible ring 1, advances the male screw 10 by applying torque by the torque operating portion 4 and when the torque becomes constant, as shown by FIG. 23B, the torque operating portion 4 is broken to thereby prevent further clamping. Notation D′ designates the nut of the invention in a state of reaching a specified clamping torque.

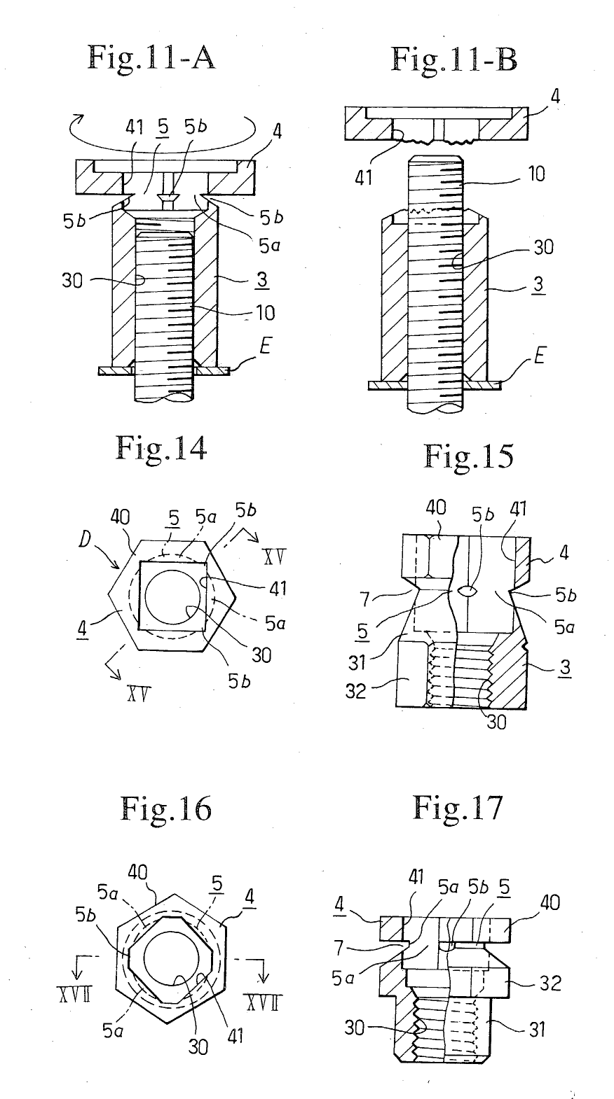

When a state in use is explained with reference to FIG. 6A and FIG. 6B and FIG. 11A and FIG. 11B, FIG. 6A (FIG. 11A) shows a state in which the male screw 10 of the compressible ring 1 is screwed to the female screw hole 30 of the nut main body 3 and torque starts being applied to the torque operating portion 4 by engaging a tool T such as a spanner and a monkey wrench thereto.

In the state, the applied torque is transmitted to the nut main body 3 via the strength portion 5a of the torque restraining portion 5 and the nut main body 3 is pivoted integrally with the torque operating portion 4 and therefore, the male screw 10 advances in an axial direction of the female screw hole 30. By contracting the diameter of the compressible ring 1 in this way, resistance thereof is transmitted from the nut main body 3 to the torque operating portion 4.

An entire periphery of the torque restraining portion 5 is not constituted by a wall having a uniform thickness but locally includes the fragile portion 5b and the sectional strength is intentionally reduced by that amount. Therefore, when a set torque is reached, the strength portion 5a cannot withstand twisting and is broken and as shown by FIG. 6B (FIG. 11B), the torque operating portion 4 is separated from the nut main body 3 while projecting the male screw 10 from the nut main body 3.

When the torque operating portion 4 is removed in this way, the nut main body 3 cannot further be applied with torque and clamping by the compressible ring 1 is forcibly finished. Therefore, a firm and stable clamped state is achieved without destructing the screw or cutting or thinning the pressure resistant hose A by excessive fastening.

Further, the outlook of the nut is changed by separating the torque operating portion 4 and therefore, it can instantly be determined from outside whether clamping has been finished or not. When the fragile portion 5b is the window hole, a degree of advancing the male screw 10 can optically be recognized therethrough and therefore, it can be sensed that a timing of reaching the specified torque is near and one can prepare for occurrence of shock beforehand when the torque operating portion 4 is separated.

Further, when planar dimensions of the torque operating portion 4 are made larger than those of the nut main body 3, there is achieved an advantage that the tool T is not erroneously applied to the nut main body 3.

Further, when the noncircular hole 41 is constituted by a shape by which a wrench or the like cannot be pivoted even when the wrench is inserted thereinto as in the first mode or the second mode, erroneous operation can be prevented.

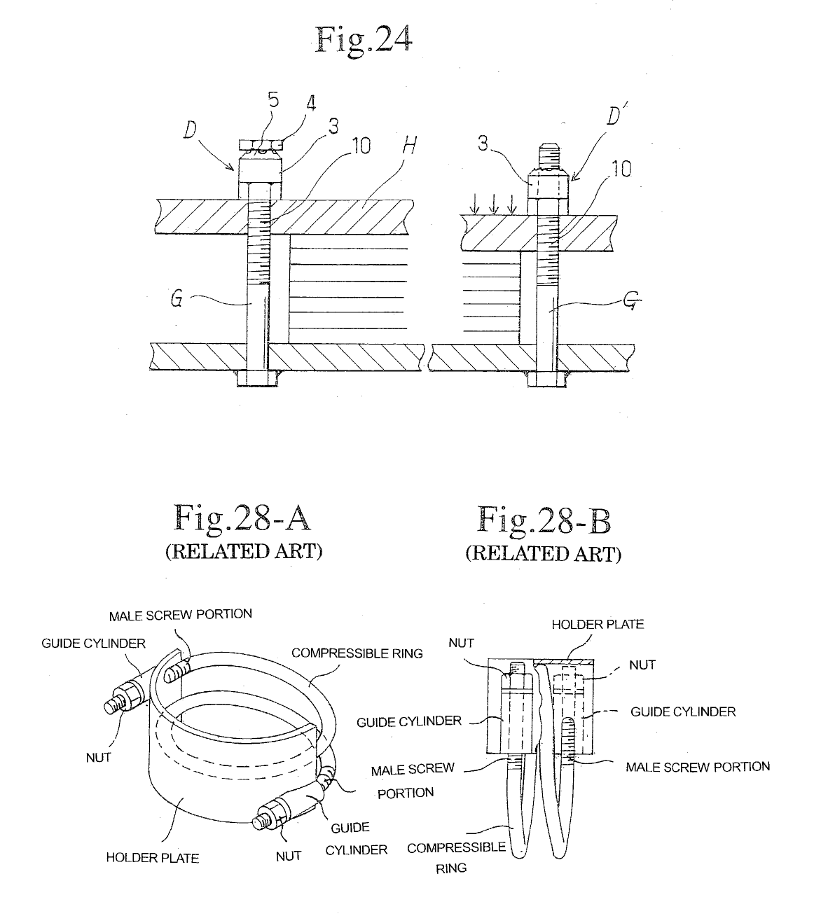

FIG. 24 shows an example of applying the torque restraining nut D of the invention to means for pressing laminated members by a press plate H, the left side of the drawing shows the state before applying torque of the nut D of the invention and the right side of the drawing shows a state after applying the torque (D′).

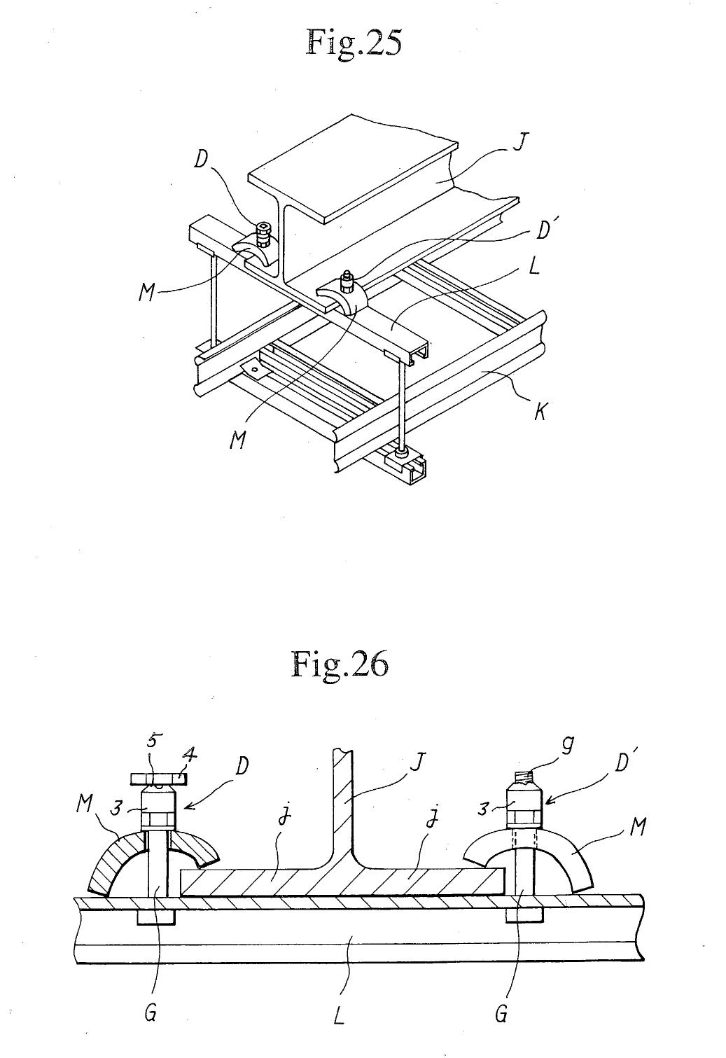

FIG. 25 shows an example of applying the torque specifying nut D of the invention to electric construction. That is, when a cable duct or the like K is hung from a beam J fixed to a ceiling by a hang metal piece, the beam J is clamped to a hang channel L. The hang channel L is unrotatably arranged with a bolt G, the bolt G is inserted into a clamp metal piece M engaged with flanges j of the beam J and the nut D of the invention is used to attach to a male screw g of the bolt G to thereby press the clamp metal piece M by the specified torque. In the drawing, the left side shows the state before applying the torque of the nut D of the invention and the right side shows the state D′ after applying the torque.

FIG. 27 shows an example of applying the invention to connection between a chain P and a stool Q of a swing. A bolt (U bolt or eye bolt) G is caught by a chain P at a distal end thereof and screw shafts g penetrate holes provided at the stool Q and extended downwardly. The nut D of the invention is attached to the screw shaft via a washer E and is clamped by a specified torque. In the drawing, the right side shows a state before applying the torque of the nut D of the invention and the left side shows a state D′ after applying the torque.

What is claimed is:

1. A torque specifying nut integrally formed with a nut main body (3) having a female screw hole (30) and a torque operating portion (4) having a tool applying face (40) at an outer side thereof, wherein the torque operating portion (4) is formed with a noncircular hole (41) concentric with the female screw hole (30) and having a diameter larger than a diameter of the female screw hole from an upper end face thereof by a depth reaching the nut main body (3) and at a boundary portion of the nut main body (3) and the torque operating portion (4), as a torque restraining portion (5), a plurality of fragile portions (5b) are arranged around the noncircular hole (41) at intervals in a peripheral direction.

2. The torque specifying nut according to claim 1, wherein the fragile portion (5b) is constituted by changing a thickness of a wall thereof surrounding the noncircular hole (41) in the peripheral direction by a relationship between a necked portion (7) formed at the boundary portion of the nut main body (3) and the torque operating portion (4) and the noncircular hole (41).

3. The torque specifying nut according to claim 1, wherein the fragile portion (5b) is selected from a range of two through five pieces thereof and each of the fragile portions (5b) comprises a window hole for communicating the noncircular hole (41) to outside thereof.

4. The torque specifying nut according to claim 1, wherein an outer diameter of the torque operating portion (4) is larger than an outer diameter of the nut main body (3).

5. The torque specifying nut according to claim 1, wherein the nut main body (3) includes a tool applying face (32) at a portion thereof.

6. The torque specifying nut according to claim 1, wherein the noncircular hole (41) is constituted by a planar polygonal shape or a shape similar thereto.
